(19) United States
(12) Patent Application Publication
(10) Pub. No.: US 2026/0055794 A1
(43) Pub. Date: Feb. 26, 2026

(54) ROTATION BRAKING DEVICE

(71) Applicant: NTN Corporation, Osaka (JP)

(72) Inventors: Koji SATO, Shizuoka (JP); Takahide Saito, Shizuoka (JP)

(73) Assignee: NTN Corporation, Osaka (JP)

(21) Appl. No.: 19/307,556

(22) Filed: Aug. 22, 2025

(30) Foreign Application Priority Data
Aug. 23, 2024 (JP) 2024-142016

(51) Int. Cl. F16D 63/00; F16D 65/16; F16D 121/22

(52) U.S. Cl. CPC F16D 63/004; F16D 63/002; F16D 65/16; F16D 2121/22; F16D 2200/0008; F16D 2250/0046; F16D 2250/0053

(57) ABSTRACT

A rotation braking device includes a cage disposed so as to be movable between an engagement position at which engagement elements are engaged with an inner member and an outer member, and a disengagement position at which the engagement elements are disengaged from the inner member and the outer member; a centering spring rotationally fixed to the cage; an axially movable friction member rotationally fixed to the cage; a separation spring for biasing the friction member in the direction away from an electromagnet via an armature; and a friction surface portion configured to axially receive the biased friction member and to apply a circumferential force to the friction member. The friction member is attracted to the armature when the electromagnet is energized. A surface treatment for reducing friction resistance is applied to at least one of opposed contact surfaces of the friction member and the armature.

### TECHNICAL FIELD

The present invention relates to a non-excited operation type rotation braking device.

### BACKGROUND ART

Conventionally, a non-excited operation type rotation braking device used for braking a rotary shaft is known in which engagement elements are disposed between an inner member and an outer member surrounding the inner member, the engagement elements are retained by a cage, the cage is moved to an engagement position when an electromagnet is de-energized such that the engagement elements are engaged with the inner member and the outer member, whereby relative rotation between the inner member and the outer member is prevented, and the cage is moved to a disengagement position when the electromagnet is energized such that the engagement elements are disengaged from the inner member and the outer member, whereby relative rotation between the inner member and the outer member is allowed.

For example, in the non-excited operation type rotation braking device disclosed in the below-identified Patent Document 1, the inner member is connected to the rotary shaft of the different machine, and the outer member is rotationally fixed to the case. The case is attached to a stationary system. The cage is elastically retained at the disengagement position by the centering spring. The centering spring is rotationally fixed to the inner member and the cage so as to rotate in unison with the inner member. The friction member and the armature are arranged so as to be axially opposed to the electromagnet. The friction member is disposed so as to be rotationally fixed to the cage and be axially movable. The armature is arranged between the electromagnet and the friction member. The separation spring is disposed for axially biasing the friction member in the direction away from the electromagnet via the armature. The friction surface portion is disposed to axially receive the friction member biased by the separation spring, and to apply to the friction member a circumferential force (i.e., a friction torque) for moving the cage to the engagement position. Since the biasing force of the separation spring is not applied to the friction member when the electromagnet is energized, the friction member is not pressed against the friction surface portion. Accordingly, even when the inner member and the outer member relatively rotate in the energized state of the electromagnet, the cage is elastically retained at the disengagement position by the centering spring. As a result, the engagement elements cannot be engaged with the inner member and the outer member, whereby a free state is maintained in which relative rotation between the inner member and the outer member is allowed. On the other hand, when the electromagnet is de-energized, the friction member is axially biased in the direction away from the electromagnet via the armature by the separation spring, and is thereby pressed against the friction surface portion. Accordingly, when the inner member rotates relative to the outer member in the de-energized state of the electromagnet, the friction surface portion, which axially receives the friction member, applies a circumferential force to the friction member so as to brake relative rotation of the friction member at an axial contact portion with the friction member and to move the cage, which is rotationally fixed to the friction member, to the engagement position. As a result, the centering spring is elastically deformed and the cage is moved to the engagement position. Therefore, the engagement elements are engaged with the inner member and the outer member. Consequently, a braking state is achieved in which the relative rotation between the inner member and the outer member is prevented via the engagement elements.

### PRIOR ART DOCUMENT(S)

### Patent Document(s)

Patent Document 1: Japanese Unexamined Patent Application Publication No. 2023-45468

### SUMMARY OF THE INVENTION

### Problems to be Solved by the Invention

As in the rotation braking device disclosed in Patent Document 1, in the case of a non-excited operation type rotation braking device in which the movement of the cage retaining the engagement elements, between the engagement position and the disengagement position is carried out in cooperation with the centering spring, the friction member, the armature, the friction surface portion, the electromagnet, and the separation spring, when the electromagnet is energized, the armature is axially attracted toward the electromagnet and the separation spring is compressed accordingly. As a result, separation of the friction member from the friction surface portion is allowed. In an unstable state where the position of the friction member is not maintained when the electromagnet is energized and relative rotation occurs between the inner member and the outer member, axial contact may occur between the friction member and the friction surface portion. This may lead to wear at the contact portion between the friction member and the friction surface portion.

As a countermeasure against the above-mentioned risk, the inventors have conceived an arrangement in which the friction member is magnetically attracted toward the armature when the electromagnet is energized. With this arrangement, the position of the friction member can be stabilized when the electromagnet is energized.

However, upon further consideration of this countermeasure, the inventers have found that, when the magnetic attraction force acting on the friction member from the armature, which is attracted to a predetermined portion of the stationary system by the magnetic force of the electromagnet, is excessively strong, a problem may arise in which the friction resistance from the stationary system acting on the friction member increases and as a result, the cage, which is rotationally fixed to the friction member, may fail to return to the disengagement position by the spring force of the center spring.

In view of the above-described background, it is an object of the present invention to provide a non-excited operation type rotation braking device that can facilitate the return of a cage to a disengagement position when an electromagnet is energized from a de-energized state, while stabilizing the position of a friction member when the electromagnet is energized.

### Means for Solving the Problems

In order to achieve the above object, in the first means of the present invention, the present invention provides a rotation braking device including: an inner member; an outer member surrounding the inner member; engagement elements disposed between the outer member and the inner member; a cage retaining the engagement elements, and disposed to be circumferentially movable between an engagement position at which the engagement elements are engaged with the outer member and the inner member, and a disengagement position at which the engagement elements are disengaged from the outer member and the inner member; a centering spring for elastically holding the cage at the disengagement position, the centering spring being rotationally fixed to the cage; an electromagnet; an axially movable friction member rotationally fixed to the cage; an armature axially opposed to the electromagnet between the electromagnet and the friction member; a separation spring for axially biasing the friction member in a direction away from the electromagnet via the armature; and a friction surface portion configured to axially receive the friction member biased by the separation spring, and to apply to the friction member a circumferential force for moving the cage to the engagement position, characterized in that the friction member is configured to be attracted to the armature when the electromagnet is energized, wherein a surface treatment for reducing friction resistance is applied to at least one of opposed contact surfaces of the friction member and the armature (arrangement 1).

With the arrangement 1, when the electromagnet is energized, the friction member is attracted to the armature, enabling stabilization of the position of the friction member. In addition, when the electromagnet is energized from a de-energized state, even if the friction member is attracted to the armature, the friction resistance between the contact surfaces of the friction member and the armature is reduced by the surface treatment. This makes it possible to reduce the friction resistance from the stationary system acting on the friction member, and to facilitate the return of the cage to the disengagement position by the spring force of the centering spring.

In the second means of the present invention, the present invention provides a rotation braking device including: an inner member; an outer member surrounding the inner member; engagement elements disposed between the outer member and the inner member; a cage retaining the engagement elements, and disposed to be circumferentially movable between an engagement position at which the engagement elements are engaged with the outer member and the inner member, and a disengagement position at which the engagement elements are disengaged from the outer member and the inner member; a centering spring for elastically holding the cage at the disengagement position, the centering spring being rotationally fixed to the cage; an electromagnet; an axially movable friction member rotationally fixed to the cage; an armature axially opposed to the electromagnet between the electromagnet and the friction member; a separation spring for axially biasing the friction member in a direction away from the electromagnet via the armature; and a friction surface portion configured to axially receive the friction member biased by the separation spring and to apply to the friction member a circumferential force for moving the cage to the engagement position, characterized in that the friction member is configured to be attracted toward the armature when the electromagnet is energized, wherein at least one of opposed surfaces of the friction member and the armature has a circumferentially extending raceway groove, wherein a plurality of rolling elements circumferentially rollable along the raceway groove are disposed between the opposed surfaces, and wherein the friction member and the armature are disposed so as to be supported by the rolling elements in a manner that allows relative rotation between the friction member and the armature when the electromagnet is energized (arrangement 2).

With the arrangement 2, when the electromagnet is energized, the friction member is attracted toward the armature, and the friction member is supported via the plurality of rolling elements, thereby allowing the position of the friction member to be stabilized. In addition, when the electromagnet is energized from a de-energized state, even if the friction member is attracted toward the armature, the friction member is supported by the plurality of rolling elements circumferentially rollable along the raceway groove, so as to be rotatable relative to the armature. This makes it possible to reduce the friction resistance from the stationary system acting on the friction member, and to facilitate the return of the cage to the disengagement position by the spring force of the centering spring.

In the arrangement 1 or 2, an arrangement 3 may be used in which the friction member and the armature are each formed of a magnetic material.

With the arrangement 3, a magnetic circuit can be formed such that both the friction member and the armature are attracted by the magnetic force of the electromagnet.

In any one of the arrangements 1 to 3, an arrangement 4 may be used in which a heat treatment for increasing surface hardness is applied to the friction member and the armature.

With the arrangement 4, it is possible to prevent wear in the sliding portions of the friction member and the armature, as well as surface damage in the raceway groove when the plurality of rolling elements are used in accordance with the above-described second means.

### Effects of the Invention

As described above, according to the present invention, by using the arrangement 1 or the arrangement 2, wear can be prevented in the friction member and the friction surface portion of the non-excited operation type rotation braking device.

### BRIEF DESCRIPTION OF THE DRAWINGS

FIG. 1 is a sectional view showing a rotation braking device according to a first embodiment of the present invention in a non-excited operation state.

FIG. 2 is a sectional view taken along line II-II in FIG. 1.

FIG. 3 is an enlarged sectional view showing the vicinity of the contact surface between the friction member and the armature when the electromagnet is energized from the state shown in FIG. 1.

FIG. 4 is a sectional view showing a rotation braking device according to a second embodiment of the present invention in a non excited operation state.

FIG. 5 is a sectional view showing a rotation braking device according to a third embodiment of the present invention in a non-excited operation state.

FIG. 6 is a sectional view showing a rotation braking device according to a fourth embodiment of the present invention in a non-excited operation state.

### BEST MODE FOR CARRYING OUT THE INVENTION

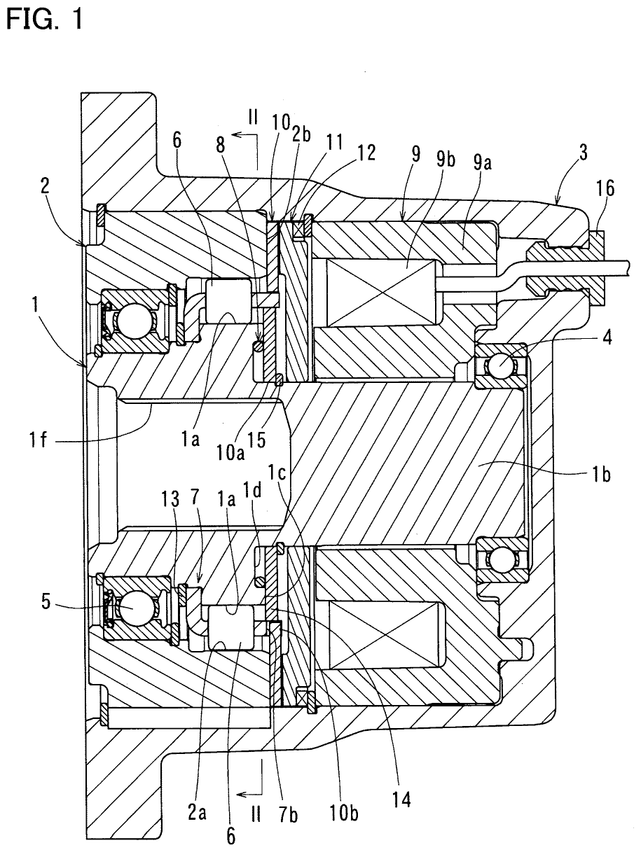

A rotation braking device according to a first embodiment (hereinafter simply referred to as “this rotation braking device”), as an example employing the first means of the present invention, will be described with reference to FIGS. 1 to 3.

This rotation braking device shown in FIG. 1 includes an inner member 1; an outer member 2 that surrounds the inner member 1; a clutch mechanism configured to allow and interrupt transmission of rotational torque between the inner member 1 and the outer member 2; a case 3 that surrounds the outer member 2 and houses the clutch mechanism.

As used herein, the terms “axial” and “axially” refer to the direction along a center axis around which the inner member 1 and the outer member 2 rotate relative to each other; the terms “radial” and “radially” refer to the direction orthogonal to the center axis; and the terms “circumferential” and “circumferentially” refer to the direction around the center axis. In the following description of the first embodiment, the terms “right” and “rightward” refer to one axial side in FIG. 1, and the terms “left” and “leftward” refer to the other axial side, which is opposite from the one axial side in FIG. 1.

The inner member 1 is connected to a rotary shaft (not shown) of a different apparatus (or system) so as to be a component belonging to a rotational system. The case 3 is a shell body including a tubular portion that surrounds the outer member 2 and the clutch mechanism, and the case 3 is fixed to a stationary portion (not shown) that remains stationary relative to the rotary shaft of the different apparatus so as to be a component belonging to a stationary system. The outer member 2 is fitted in the case 3. The outer member 2 is circumferentially rotationally fixed to the case 3 by an appropriate structure such as a key, and axial movement of the outer member 2 relative to the case 3 is restricted by a snap ring or the like.

The different system/apparatus, in which this rotation braking device is used, is, e.g., a driving system or a steering apparatus disposed in vehicles, vessels, or construction machines. This rotation braking device is used as, e.g., (i) a brake for preventing motion of tires for steering or rear-wheel driving; or (ii) a brake for preventing rotation of a rotary shaft of a steering wheel. The stationary portion to which the case 3 is fixed is, e.g., a body such as a vehicle body or a housing of a reaction motor disposed in a steering apparatus.

The case 3 is a cup-shaped seamless integral member comprising a tubular portion that is open leftward; and a bottom portion that closes the right end of the tubular portion. A rolling bearing 4 which supports the end of the inner member 1 on the right side such that the inner member 1 is rotatable relative to the case 3 is disposed between the inner periphery of the case 3 and the inner member 1. A rolling bearing 5 which supports the end of the inner member 1 on the left side such that the inner member 1 is rotatable relative to the outer member 2, is disposed between the inner periphery of the outer member 2 and the inner member 1. The inner member 1 and the outer member 2 are disposed so as to be rotatable relative to each other with a predetermined coaxiality, by the rolling bearings 4 and 5. The inner member 1, the outer member 2, and the case 3 may be each constituted by a single member or multiple members combined, as appropriate.

Each rolling bearing 4, 5 is a non-separable radial bearing capable of supporting/withstanding axial loads in opposite directions. In the shown example, each rolling bearing 4, 5 is a deep groove ball bearing.

The clutch mechanism include cam surfaces 1a formed on the outer periphery of the inner member 1; a cylindrical surface 2a formed on the inner periphery of the outer member 2; engagement elements 6 disposed between the respective cam surfaces 1a and the cylindrical surface 2a; a cage 7 retaining the engagement elements 6; a centering spring 8 rotationally fixed to the inner member 1 and the cage 7; an electromagnet 9 attached to the case 3; an axially movable friction member 10 rotationally fixed to the cage 7; an armature 11 disposed between the electromagnet 9 and the friction member 10; a separation spring 12 biasing the friction member 10 via the armature 11; and a friction surface portion 2b disposed on the side surface of the outer member 2 on the right side.

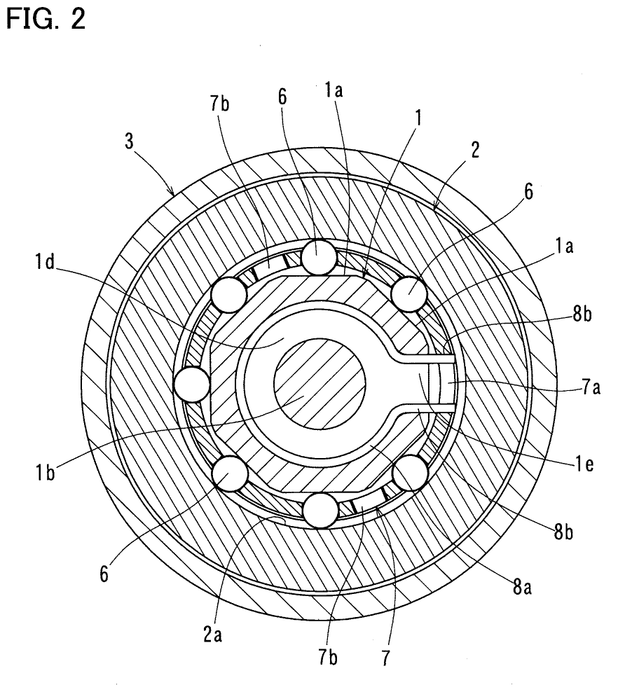

As shown in FIG. 2, the cylindrical surface 2a of the clutch mechanism extends circumferentially around the entire circumference. Wedge-shaped spaces are defined between the cylindrical surface 2a and the respective cam surfaces 1a. Each wedge-shaped space gradually narrows from the circumferential center of the cam surface 1a toward both circumferential ends of the cam surface 1a. Specifically, the radial distance between each cam surface 1a and the cylindrical surface 2a gradually decreases from the position of the engagement element 6 (see FIG. 2) located at the circumferential center of the cam surface 1a toward one circumferential side (i.e., toward the side in the counterclockwise direction in FIG. 2), and also gradually decreases from the above position of the engagement element 6 toward the other circumferential side (i.e., toward the side in the clockwise direction in FIG. 2). The (plural) cam surfaces 1a on the outer periphery of the inner member 1 are circumferentially spaced apart from each other, and the engagement elements 6 are disposed in the (plural) wedge-shaped spaces, respectively. While, in the shown example, each cam surface 1a is a single flat surface, the cam surface may be constituted by a plurality of surfaces or be a single curved surface.

As shown in FIGS. 1 and 2, the inner member 1 is formed integrally and seamlessly with the plural cam surfaces 1a; an axially extending center shaft portion 1b; an end surface portion 1c located around the center shaft portion 1b; a circular arc-shaped recess 1d extending circumferentially between the center shaft portion 1b and the end surface portion 1c; a penetrating groove 1e extending radially linearly from both circumferential ends of the circular arc-shaped recess 1d to the outer periphery of the inner member 1; and a coupling portion 1f formed on the inner periphery of the inner member 1.

The cam surfaces 1a are located on a protruding portion of the inner member 1 protruding radially toward the outer member 2 relative to the center shaft portion 1b, and the end surface portion 1c, the circular arc-shaped recess 1d, and the penetrating groove 1e are formed on the side surface of this protruding portion on the right side. The end surface portion 1c is a radially extending flat surface. The circular arc-shaped recess 1d and the penetrating groove 1e are open rightward, and are recessed from the end surface portion 1c toward the left side. The coupling portion 1f is connected to the rotary shaft of the different apparatus by spline fitting.

As shown in FIG. 1, the outer member 2 is an annular member that is open rightward and leftward. The opening of the outer member 2 on the right side is larger in diameter than the opening of the outer member 2 on the left side. The outer member 2 is formed integrally and seamlessly with the cylindrical surface 2a on the inner periphery of the outer member 2, and the friction surface portion 2b on the end surface of the outer member 2 on the right side. The friction surface portion 2b is a radially extending flat surface.

When the cage 7 rotates relative to the inner member 1, the engagement elements 6 engage with the cylindrical surface 2a and the cam surfaces 1a, thereby transmitting rotational torque between the inner member 1 and the outer member 2. Each engagement member 6 has a cylindrical roller shape.

As shown in FIG. 2, the cage 7 is an annular member having a plurality of circumferentially spaced apart pockets in which the respective engagement members 6 are received. The engagement elements 6 are restricted in the circumferential positions relative to the cam surfaces 1a by circumferentially abutting against the cage 7, and the engagement elements 6 are forcibly rotated together with the cage 7. As shown in FIG. 1, an inner flange portion of the cage 7 is radially supported by the inner member 1. Axial movement of the cage 7 is restricted by a snap ring 13 attached to the inner member 1 so as to be located on the left side of the inner flange portion of the cage 7, and by a step portion of the inner member 1 located on the right side of the inner flange portion of the inner member 1 of the cage 7.

The cage 7 is movable circumferentially around a common axis relative to the inner member 1, between a predetermined engagement position and a predetermined disengagement position. The engagement position is a position where each engagement element 6 is engaged with the cam surface 1a and the cylindrical surface 2a by being circumferentially moved from the circumferential center of the cam surface 1a. The disengagement position is a position where each engagement element 6 is disengaged from the cam surface 1a and the cylindrical surface 2a by being moved toward the circumferential center of the cam surface 1a.

The centering spring 8 is a spring member for elastically holding the cage at the disengagement position, and for transmitting rotational torque of the inner member 1 to the cage 7. As shown in FIG. 2, the centering spring 8 comprises a circular arc-shaped spring portion 8a formed by winding a steel wire into an circular arc shape so as to extend in the circumferential direction, and two extensions 8b that extend radially outward from both circumferential ends of the circular arc-shaped spring portion 8a, respectively.

The circular arc-shaped spring portion 8a is fitted in the circular arc-shaped recess 1d. The two extensions 8b are inserted in the penetrating groove 1e so as to protrude from the penetrating groove 1e at their distal ends. The distal ends of the two extensions 8b are inserted in an annular engagement groove 7a formed on the right side of the cage 7. The two extensions 8b can come into contact with both circumferential ends of the penetrating groove 1e, and both circumferential ends of the engagement groove 7a. Due to this, the centering spring 8 is rotationally fixed to the inner member 1 so as to rotate in unison with the inner member 1, and is rotationally fixed to the cage 7. In addition, the centering spring 8 can elastically hold the cage 7 by applying a circumferential spring force to the engagement groove 7a via the extensions 8b.

As shown in FIG. 1, a spring pressing member 14 for restricting movement of the centering spring 8 toward the right side is disposed inside of the cage 7. The spring pressing member 14 is a ring-shaped member through which the center shaft portion 1b is inserted. The side surface of the spring pressing member 14 on the left side is adjacent to the centering spring 8 and the end surface portion 1c. A snap ring 15 is attached to the center shaft portion 1b so as to be located on the right side of, and adjacent to, the side surface of the spring pressing member 14 on the right side. Axial movement of the spring pressing member 14 is restricted by the snap ring 15 and the end surface portion 1c.

The electromagnet 9 includes an annular core 9a having a C-shaped cross-section which is open axially toward the armature 11, and a solenoid coil 9b wound around the core 9a. The core 9a is a bobbin formed of a ferromagnetic material, and functioning as a yoke. The core 9a is fixed to the bottom of the case 3. The cage 3 is formed with a through-hole through which a lead wire for supplying an electric power to the solenoid coil 9b is inserted. A rubber grommet 16 is mounted on the case 3 so as to seal the gap defined between the through-hole and the lead wire. The state of the electromagnet 9 is switched from a de-energized state to an energized state by energizing the solenoid coil 9b.

The friction member 10 is formed of a magnetic material such as a steel plate. The friction member 10 is an annular member inserted between the inner periphery of the case 3 and the cage 7 so as to be axially opposed to the friction surface portion 2b and the side surface of the armature 11 on the left side. The friction member 10 is guided radially and axially along the inner periphery of the case 3 or the outer periphery of the cage 7. As a result, the friction member 10 is axially movable between the friction surface portion 2b and the side surface of the armature 11 on the left side while maintaining a predetermined coaxiality with the inner member 1 and the outer member 2.

The friction member 10 includes an inner end portion 10a axially slidably fitted to the center shaft portion 1b, and an engagement protrusion 10b that radially protrudes from the inner end portion 10a toward the center shaft portion 1b. The engagement protrusion 10b is fitted in a cutout 7b formed on the right side of the cage 7, and is engageable with the cutout 7b on either circumferential side. Due to the circumferential engagement between the engagement protrusion 10b and the cutout 7b, the friction member 10 is rotationally fixed to the cage 7. The axial widths of the engagement protrusion 10b and the cutout 7b are set such that the friction member 10 is always engageable in the circumferential direction over the entire reciprocating stroke of axial movement between the friction surface portion 2b and the armature 11.

The spring pressing member 14 may be omitted. In this case, a rotationally fixing structure may be used in which movement of the centering spring toward the right side from the recess is restricted by the flange portion of the cage, and a protruding portion of the cage is axially inserted in an engagement window of the friction member. In addition, a known structure may be used in which the spring pressing member or a connecting member different therefrom is circumferentially engaged with the cage and the friction member, thereby rotationally fixing the cage and the friction member to each other via the spring pressing member or the connecting member.

The armature 11 is formed of a magnetic material such as a steel plate, and is axially opposed to the electromagnet 9. The armature 11 is an annular member that is slidably fitted to the outer periphery of the center shaft portion 1b. The armature 11 does not include a portion that engages circumferentially with the inner member 1, and, therefore, is not rotatable in unison with the inner member 1. The armature 11 has an outer diameter equal or similar to the outer diameter of the friction member 10, and the armature 11 is shaped such that the radially outer side of the armature 11 can axially come into contact with the friction member 10, and such that the radially inner side of the armature 11 cannot come into contact with the friction member 10. While the electromagnet 9 is de-energized, the armature 11 is elastically held at a predetermined set position (i.e., the position shown in FIG. 1) by the separation spring 12, and. when the electromagnet 9 is energized, the armature 11 is magnetically attracted from the set position. The set position is set to an axially opposed position such that a friction torque equal to or greater than a predetermined value is applied among the friction surface portion 2b, the friction member 10, and the armature 11.

The separation spring 12 is a spring member for biasing the armature 11 leftward, and also for biasing the friction member 10 leftward via the armature 11. The separation spring 12 is disposed between the side surface of the armature 11 on the right side and the end surface of the core 9a on the left side. The separation spring 12 is placed in a preloaded state (or stores force) by moving the armature 11 from the set position rightward. The separation spring 12 is, e.g., a metallic spring having a wave washer shape or a coil shape.

When the inner member 1, which belongs to the rotational system, rotates relative to the outer member 2, which belongs to the stationary system, during de energization of the electromagnet 9, the friction surface portion 2b, which belongs to the stationary system, can apply a circumferential force (i.e., friction torque) as friction resistance, to the left side surface of the friction member 10, which belongs to the rotational system, at the set position together with the inner member 1, the engagement elements 6, and the cage 7.

When the electromagnet 9 is energized, a magnetic circuit is formed such that the magnetic flux from the electromagnet 9 enters the armature 11, which is formed of a magnetic material, further enters the friction member 10, which is formed of a magnetic material, from the armature 11, and then returns from the friction member 10 via the armature 11 to the electromagnet 9. Accordingly, by the formation of the magnetic circuit, the armature 11 and the friction member 10 are magnetically attracted from the set position rightward, the side surface of the armature 11 on the right side is attracted to the electromagnet 9 against the biasing force of the separation spring 12, and the side surface of the friction member 10 on the right side is attracted to the side surface of the armature 11 on the left side. As a result, during energization of the electromagnet 9, the friction member 10 attracted to the armature 11 is held in a stable position where the friction member 10 is not pressed against the friction surface portion 2b.

While the electromagnet 9 is energized, the cage 7 is maintained at the disengagement position by the spring force of the centering spring 8, and the engagement elements 6 are maintained at a position where the engagement elements 6 are not engaged with the cylindrical surfaces 2a and the cam surfaces 1a. As a result, even if the inner member 1 rotates relative to the outer member 2 in either the normal direction or the reverse direction, the rotational torque is not transmitted between the inner member 1 and the outer member 2, so that the inner member 1 is rotatable freely relative to the outer member 2. For example, when the inner member 1 rotates relative to the outer member 2 in the normal direction, the inner member 1, which is elastically coupled via the centering spring 8, rotates in the normal direction together with the cage 7 at the disengagement position, the engagement elements 6, which are retained by the cage 7, also move in the normal direction, and the friction member 10, which is rotationally fixed to the cage 7, rotates together with the cage 7 in the normal direction without being pressed against the friction surface portion 2b.

When the state of the electromagnet 9 is switched from the energized state to the de-energized state, the armature 11 is moved leftward, i.e., in the direction away from the electromagnet 9, so that the armature 11 and the friction member 10 are promptly returned to their set positions. When the inner member 1 rotates relative to the outer member 2 during de-energization of the electromagnet 9, the circumferential force (i.e., friction torque) applied from the friction surface portion 2b to the friction member 10 at the contact portion between the friction member 10 and the friction surface portion 2b, acts as friction resistance against the friction member 10, which rotates relative to the outer member 2 together with the inner member 1, the cage 7, and the like. The circumferential force (friction torque) is preset to a value greater than the spring force of the centering spring 8. Accordingly, the rotation of the cage 7 is retarded relative to the inner member 1, thereby causing elastic deformation of the centering spring 8, which is rotationally fixed to the inner member 1, rotating the cage 7 relative to the inner member 1, and moving the engagement elements 6 toward the narrow areas of the wedge-shaped spaces, which are defined between the cylindrical surface 2a and the cam surfaces 1a. As a result, the cage 7 is moved to the engagement position, thereby engaging the engagement elements 6 with the cylindrical surface 2a and the cam surfaces 1a. Accordingly, the state of the clutch mechanism is switched to a state where rotational torque of the inner member 1 is transmitted to the outer member 2 via the engagement elements 6. In this state, this rotation braking device can stop the rotation of the inner member 1 by the engagement elements 6 wedged between the cylindrical surface 2a and the cam surfaces 1a by transmitting rotational torque from the engagement elements 6 to the cylindrical surface 2a, which belongs to the stationary system.

When the state of the electromagnet 9 is switched from the de-energized state to the energized state, the armature 11 and the friction member 10 are attracted rightward by the magnetic force of the electromagnet 9, thereby reducing the circumferential force applied to the friction member 10 from the friction surface portion 2b. As a result, the cage 7 rotates relative to the inner member 1 by the spring force of the centering spring 8 in the direction opposite to the direction when the engagement is established. Consequently, the cage 7 is moved to the disengagement position, so that the engagement elements 6 are disengaged from the cylindrical surface 2a and the cam surfaces 1a. Accordingly, the state of the clutch mechanism returns to a state where transmission of rotational torque from the inner member 1 to the outer member 2 is interrupted. In this state, this rotation braking device allows rotation of the inner member 1 relative to the outer member 2.

When the electromagnet 9 is energized from the de-energized state, the armature 11, which is attracted to the electromagnet 9 that belongs to the stationary system, is not circumferentially engaged with the inner member 1. As a result, even if the inner member 1 rotates relative to the outer member 2, the armature 11 remains stationary while being attracted to the electromagnet 9. At this time, the friction member 10, which rotates together with the inner member 1 via the centering spring 8 and the cage 7, is attracted to the armature 11 that is attracted to the stationary system. Consequently, friction resistance is generated in the contact portion between the friction member 10 and the armature 11. The friction resistance acts to retard the rotation of the friction member 10 and the cage 7 relative to the rotation of the inner member 1. Consequently, the friction resistance opposes the spring force of the centering spring 8 for holding the cage 7 at the disengagement position. When the friction resistance exceeds the spring force of the centering spring 8, the cage 7, which is rotationally fixed to the friction member 10, may fail to return to the disengagement position by the spring force of the centering spring 8. There is a risk that the performance of this rotation braking device may be unstable.

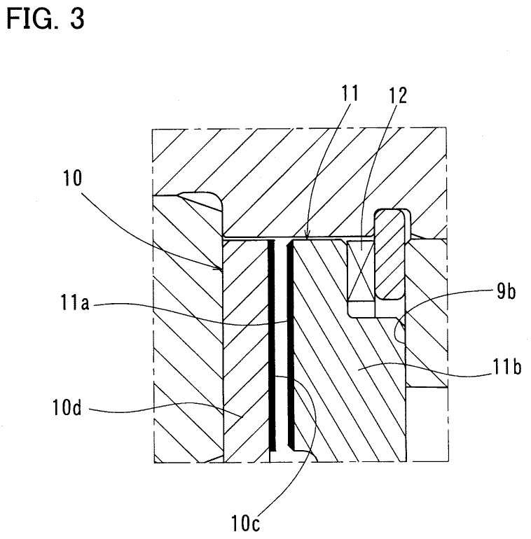

To eliminate the risk, as shown in FIG. 3, the above-mentioned surface treatment for reducing friction resistance is applied to the opposed contact surfaces 10c and 11a of the friction member 10 and the armature 11.

The contact surface 10c of the friction member 10 is a surface area of the side surface of the friction member 10 on the right side that axially contacts the side surface of the armature 11 on the left side when the electromagnet 9 is energized. The contact surface 11a of the armature 11 is a surface area of the side surface of the armature 11 on the left side that axially contacts the contact surface 10c when the electromagnet 9 is energized.

A film that forms each contact surface 10c, 11a is fixed to a predetermined surface area of a magnetic base material 10d, 11b, which respectively constitutes the friction member 10 and the armature 11, and the film fills concavities in the surface roughness profile of the corresponding base material 10d, 11b and covers its convexities. As a result, the base materials 10d and 11b are easily circumferentially slidable relative to each other without direct contact between the base materials 10d and 11b. In FIG. 3, the thicknesses of the contact surfaces 10c and 11a are exaggerated for illustrative purpose.

As the surface treatment for forming each contact surface 10c, 11a, for example, molybdenum disulfide coating or DLC (Diamond-Like-Carbon) coating can be used.

In the case of the molybdenum disulfide coating, a film can be obtained that comprises a layer containing molybdenum disulfide as a main component and, if necessary, a solid lubricant such as a fluororesin or graphite dispersed therein. As a result, excellent lubricity can be achieved.

In the case of the DLC coating, a film can be obtained that comprises an amorphous carbon layer comprising an SP2 structure that is graphitic bonding and an SP3 structure that is diamond-like bonding. As a result, when the graphitic structure is particularly dominant, excellent lubricity can be achieved.

Even if the above-mentioned surface treatment is applied to only one of the contact surface 10c of the friction member 10 and the contact surface 11a of the armature 11, it is possible to prevent sticking or the like between the two contact surfaces due to adhesion of the film that forms one of the two contact surfaces to the other of the two contact surfaces, and to improve slidability between the two contact surfaces, thereby providing the effect of reducing the above-mentioned friction resistance.

As described above, this rotation braking device (see FIGS. 1 and 3) includes the inner member 1; the outer member 2 surrounding the inner member 1; the engagement elements 6 disposed between the outer member 2 and the inner member 1; the cage 7 retaining the engagement elements 6, and disposed to be circumferentially movable between the engagement position at which the engagement elements 6 are engaged with the outer member 2 and the inner member 1, and the disengagement position at which the engagement elements are disengaged from the outer member 2 and the inner member 1; the centering spring 8 for elastically holding the cage 7 at the disengagement position, the centering spring 8 being rotationally fixed to the cage 7; the electromagnet 9; the axially movable friction member 10 rotationally fixed to the cage 7; the armature 11 axially opposed to the electromagnet 9 between the electromagnet 9 and the friction member 10; the separation spring 12 for axially biasing the friction member 10 in the direction away from the electromagnet 9 via the armature 11; and the friction surface portion 2b configured to axially receive the friction member 10 biased by the separation spring 12, and to apply to the friction member 10 a circumferential force for moving the cage 7 to the engagement position.

In this rotation braking device, the friction member 10 is configured to be attracted to the armature 11 when the electromagnet 9 is energized. As a result, the position of the friction member 10 can be stabilized when the electromagnet 9 is energized.

In addition, in this rotation braking device, the surface treatment for reducing friction resistance is applied to at least one of the opposed contact surfaces 10c and 11a of the friction member 10 and the armature 11. As a result, when the electromagnet 9 is energized from the de-energized state, even if the friction member 10 is attracted to the armature 11, the friction resistance between the contact surfaces 10c and 11a of the friction member 10 and the armature 11 is reduced by the surface treatment. This makes it possible to reduce the friction resistance from the armature 11 (the stationary system) acting on the friction member 10, and to facilitate the return of the cage 7 to the disengagement position by the spring force of the centering spring 8.

Further, in this rotation braking device, the friction member 10 and the armature 11 are each formed of a magnetic material. As a result, the magnetic circuit can be formed such that both the friction member 10 and the armature 11 are attracted by the magnetic force of the electromagnet 9.

In this rotation braking device, while an example is shown in which the friction member 10 and the armature 11 are each formed from a single, seamless magnetic member, it is not necessary to form the friction member and the armature from a single member. For example, the friction member may be formed from two members bonded together: a first member that is formed of a magnetic material and faces the armature, and a second member that is formed of a magnetic or non-magnetic material and faces the friction surface portion, wherein the surface of the second member may have a non-slip property when pressed against the friction surface portion.

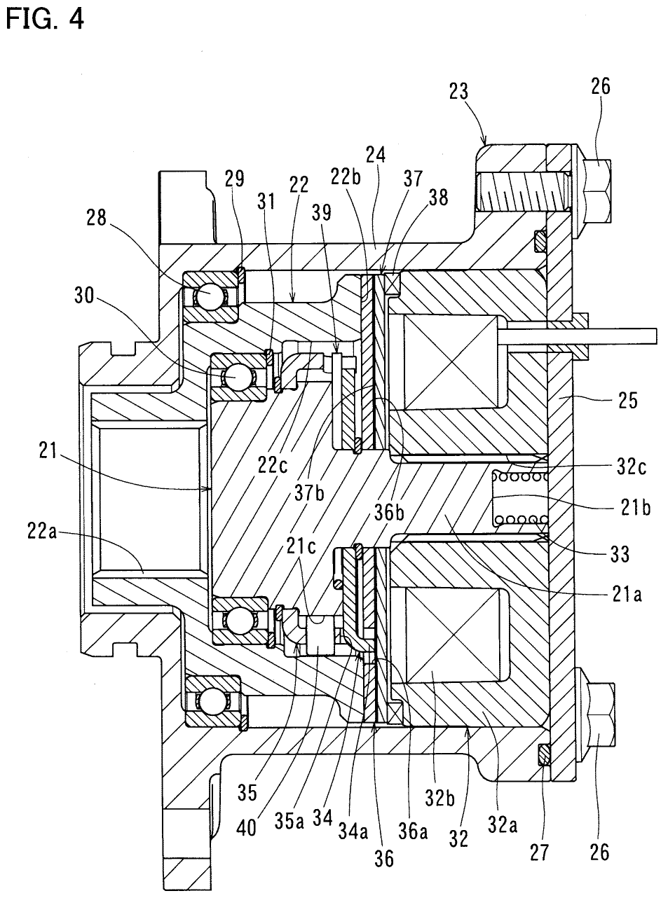

In this rotation braking device, while a structure is exemplified in which the inner member 1 is connected to the rotary shaft of the different apparatus, a structure in which the outer member is connected to the rotary shaft may alternatively be used. A second embodiment as such an example is shown in FIG. 4. The following description focuses only on the differences from the first embodiment, and corresponding components are denoted by the same reference numerals.

In the rotation braking device shown in FIG. 4, the rotary shaft (not shown) of the different apparatus is connected, from among the inner member 21 and the outer member 22, to the outer member 22. The outer member 22 is disposed so as to be rotatable relative to the case 23, and the inner member 21 is rotationally fixed to the case 23.

The case 23 includes a tubular member 24 that surrounds the clutch mechanism, and a cover member 25 that is connected to the tubular member 24. The tubular member 24 has a shape that is open leftward and rightward, with the opening thereof on the right side having a larger diameter than the opening thereof on the left side. The cover member 25 has a flat plate shape that radially and straightly extends. The tubular member 24 and the cover member 25 are each a single, seamless member, respectively. The right end surface of the tubular member 24 and the left end surface of the cover member 25 are axially fastened together by a plurality of male screws 26. The joint between the cover member 25 and the tubular member 24 is sealed with a sealing material 27.

A rolling bearing 28 is disposed between the outer member 22 and the tubular member 24. A snap ring 29 is attached to the inner periphery of the tubular member 24. Axial movement of the outer ring of the rolling bearing is restricted by the tubular member 24 and the snap ring 29.

The outer member 22 has a shape that is open leftward and rightward, with the opening thereof on the right side having a larger diameter than the opening thereof on the left side. A rolling bearing 30 is disposed between the inner periphery of the outer member 22 and the outer periphery of the inner member 21. A snap ring 31 is attached to the inner periphery of the outer member 22. Axial movement of the rolling bearing 30 is restricted by the outer member 22 and the snap ring 31.

The outer member 22 includes a coupling portion 22a that protrudes beyond the rolling bearings 28 and 30 leftward. The coupling portion 22a are connected with the rotary shaft of the different apparatus by spline fitting.

The electromagnet 32 is fixed to the cover member 25. The core 32a includes a spline hole 32c that axially penetrates between the side surfaces of the core 32a on the right and left sides, on the radially opposite side from the wound portion of the solenoid coil 32b. A center shaft portion 21a of the inner member 21 is a spline shaft portion fitted in the spline hole 32c. The inner member 21 is rotationally fixed to the case 23, which belongs to the stationary system, via the core 32a.

The center shaft portion 21a includes an open end portion 21b that is open rightward. The open end portion 21b holds an elastic member 33 thereinside. The elastic member 33 is implemented as a compression coil spring. The elastic member 33 is axially compressed between the open end portion 21b and the cover member 25. The elastic member 33 presses the inner member 21 leftward. The leftward pressing force, generated by the elastic repulsion of the elastic member 33, is transmitted from the inner member 21, through the rolling bearing 30, the outer member 22, and the rolling bearing 28, in that order, to the tubular member 24.

The spring pressing member 34 is rotationally fixed to the cage 35 and the friction member 36. The spring pressing member 34 includes an engagement portion 34a that is fitted in a cutout 35a formed on the right side of the cage 35 and fitted in an engagement window 36a formed in the friction member 36. The spring pressing member 34 is a known structure in which the engagement portion 34a is circumferentially engageable with either the cage 35 or the friction member 36. Through such engagement, the spring pressing member 34 is circumferentially moveable in unison with the cage 35, and is also circumferentially movable in unison with the armature 37 over the entire axial reciprocating stroke of the armature 37.

When the electromagnet 32 is de-energized, the armature 37 is supported by the separation spring 38 at the set position away from the electromagnet 32, and the friction member 36 is pressed against a friction surface member 22b of the outer member 22 by the biasing force of the separation spring 38. As a result, rotational torque of the outer member 22 can be transmitted between the friction member 36 and the friction surface portion 22b. When the outer member 22 is stationary in the de-energized state, the cage 35 is elastically held at the disengagement position by the centering spring 39. When the outer member 22 rotates, the centering spring 39, the cage 35, the spring pressing member 34, and the friction member 36 all rotate together. That is, the cage 35 rotates relative to the inner member 21, which belongs to the stationary system, thereby moving the engagement elements 40 toward the narrow areas of the wedge-shaped spaces defined between the cylindrical surface 22c and the cam surfaces 21c. As a result, the cage 35 is moved to the engagement position, thereby engaging the engagement elements 40 with the cylindrical surface 22c and the cam surfaces 21c. Accordingly, the state of the clutch mechanism is switched to the engagement state where transmission of rotational torque between the inner member 21 and the outer member 22 is allowed. Since the rotational torque is transmitted to the inner member 21, which belongs to the stationary system, the rotation braking device shown in FIG. 4 can stop the rotation of the outer member 22.

When the state of the electromagnet 32 is switched from the de-energized state to the energized state in this engagement state, the armature 37 is attracted rightward against the biasing force of the separation spring 38. As a result, the separation spring 38 is axially compressed, thereby reducing the pressing force of the friction member 36 against the friction surface portion 22b. Eventually, rotational torque can no longer be transmitted between the friction member 36 and the friction surface portion 22b. In this state, the cage 35 rotates relative to the inner member 21 by the spring force of the centering spring 39 in the direction opposite to the direction when the engagement is established. Consequently, the cage 35 is moved to the disengagement position, so that the engagement elements 40 are disengaged from the cylindrical surface 22c and the cam surfaces 21c. Accordingly, the state of the clutch mechanism is switched to a disengagement state where transmission of rotational torque between the inner member 21 and the outer member 22 is interrupted. While the electromagnet 32 remains energized in the disengagement state, rotational torque is not transmitted between the inner member 21 and the outer member 22 even if the outer member 22 rotates relative to the case 23 and the inner member 21 in either the normal direction or the reverse direction. Accordingly, the outer member 22 is allowed to rotate freely relative to the inner member 21.

When the electromagnet 32 is energized from the de-energized state, the armature 27 attracted to the electromagnet 32 that belongs to the stationary system, is not circumferentially engaged with the outer member 22. As a result, even if the outer member 22 rotates relative to the inner member 21, the armature 37 remains stationary while being attracted to the electromagnet 32. At this time, the friction member 36, which rotate together with the outer member 22 via the centering spring 39, the cage 35, and the spring pressing member 34, is attracted to the armature 37 that is attracted to the stationary system. Consequently, friction resistance is generated in the contact portion between the friction member 36 and the armature 37.

The above-mentioned surface treatment for reducing friction resistance is applied to the opposed contact surfaces 36b and 37b of the friction member 36 and the armature 37.

The friction member 36 and the armature 37 are formed of a magnetic material such as a steel plate, and in the shape of a simple, radially extending circular annular plate. The inner and outer diameters of these members are set to equal or similar dimensions. Accordingly, the contact surfaces 36b and 37b are formed across the entire side surface of the friction member 36 on the right side and the entire side surface of the armature 37 on the left side.

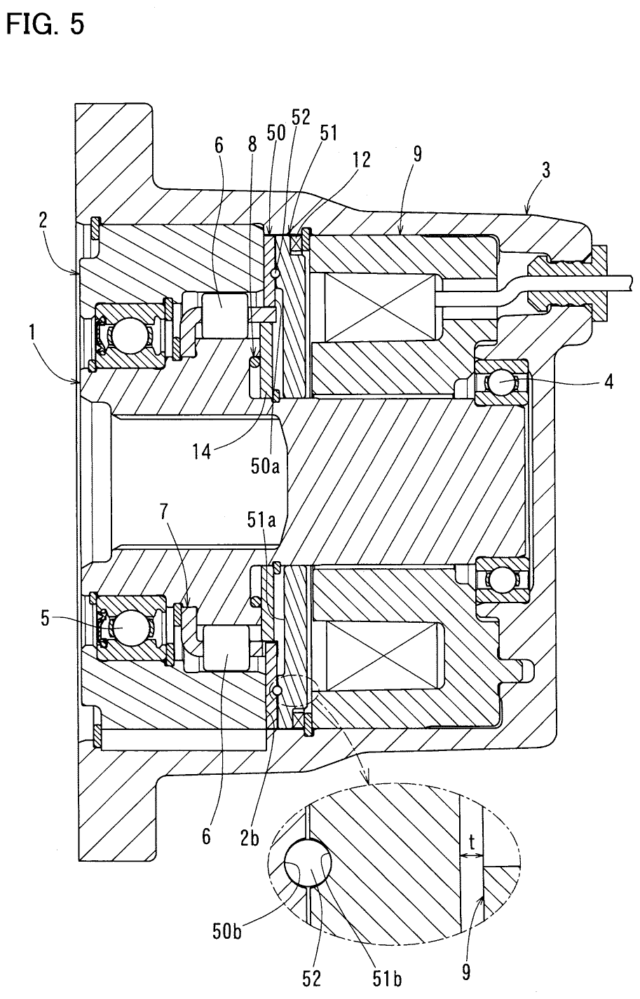

A rotation braking device according to a third embodiment, as an example employing the second means of the present invention, will be described with reference to FIG. 5. Since the third embodiment is a variation of the first embodiment, the following description focuses only on the differences from the first embodiment, and corresponding components are denoted by the same reference numerals.

In the rotation braking device shown in FIG. 5, the opposed surfaces 50a and 51a of the friction member 50 and the armature 51 are respectively provided with circumferentially extending raceway grooves 50b and 51b. The raceway groove 50b located on the side surface of the friction member 50 on the right side, and the raceway groove 51b located on the side surface of the armature 51 on the left side, are axially opposed over the entire circumference and have groove cross-sectional shapes that are symmetrical with respect to the axial direction. The plurality of rolling elements 52 circumferentially rollable along these raceway grooves 50b and 51b are disposed between the raceway grooves 50b and 51b. Balls are used as the rolling elements 52. The friction member 50 and the armature 51 are supported by the rolling elements 52 so as to be rotatable relative to each other when the electromagnet 9 is energized. As a result, the friction member 50 and the armature 51 cannot come into direct contact with each other, and, when the electromagnet 9 is energized, a gap is ensured between the friction member 50 and the armature 51, thereby preventing the friction member 50 from being attracted to the armature 51. However, the friction member 50 is attracted by magnetic flux flowing from the armature 51 toward the friction member 50, which can stabilize the position of the friction member 50.

To facilitate magnetic attraction between the friction member 50 and the armature 51, it is preferable that each rolling element 52 be formed of a magnetic material and magnetic paths be formed through the armature 51, the plurality of rolling elements 52, and the friction member 50 when the electromagnet 9 is energized. In addition, it is preferable that the total number of rolling elements 52 disposed between the raceway grooves 50b and 51b be as large as possible in order to increase the number of magnetic paths.

Specifically, steel balls are used as the rolling elements 52, and the rolling elements 52 are disposed as densely as possible within the circumferential length of the raceway grooves 50b and 51b. That is, no cage is used to retain the circumferential intervals between the rolling elements 52, and the plurality of rolling elements 52 are disposed such that circumferential gaps equal to or greater than the diameter of one rolling element 52 are not defined between the rolling elements 52.

Rollers such as needle rollers may be used as the rolling elements 52. However, since the thrust load acting on the plurality of rolling elements 52 is limited to the biasing force of the separation spring 12 and the attractive force of the electromagnet 9, within the range required for braking the cage 35, the thrust load can be sufficiently supported even by steel balls. Therefore, there is little need to adopt rollers, which have relatively higher rolling resistance, as the rolling elements.

In addition, since there is no cage retaining the rolling elements 52, it is necessary to set the diameter of each rolling element 52 to a dimension such that the rolling elements 52 are prevented from unintentionally escaping from the raceway grooves 50b and 51b due to their own weight or other factors when the armature 51 is axially moved during energization of the electromagnet 9. In the shown example, the axial movement stroke of the armature 51 during energization of the electromagnet 9 corresponds to an air gap t, which represents the axial length between the armature 51 and the electromagnet 9 when the friction member 50 is pressed against the friction surface portion 2b by the separation spring 12 in the de-energized state of the electromagnet 9. Accordingly, the diameter of each rolling element 52 is set to be greater than the air gap t (i.e., the diameter of each rolling diameter 52>t).

While an example is shown in which the friction member 50 and the armature 51 are respectively provided with the raceway grooves 50b and 51b, guidance of the plurality of rolling elements for circumferential rolling may be achieved by at least one raceway groove. Accordingly, one of the friction member and the armature may be provided with a raceway groove, and the other may be provided with a radially extending flat raceway surface along which the plurality of rolling elements roll.

As described above, the rotation braking device shown in FIG. 5 includes the inner member 1; the outer member 2 that surrounds the inner member 1; the engagement elements 6 disposed between the outer member 2 and the inner member 1; the cage 7 retaining the engagement elements 6, and disposed to be circumferentially movable between the engagement position at which the engagement elements 6 are engaged with the outer member 2 and the inner member 1, and the disengagement position at which the engagement elements 6 are disengaged from the outer member 2 and the inner member 1; the centering spring 8 for elastically holding the cage 7 at the disengagement position, the centering spring 8 being rotationally fixed to the cage 7; the electromagnet 9; the axially movable friction member 50 rotationally fixed to the cage 7; the armature 51 axially opposed to the electromagnet 9 between the electromagnet 9 and the friction member 50; the separation spring 12 for axially biasing the friction member 50 in the direction away from the electromagnet 9 via the armature 51; and the friction surface portion 2b configured to axially receive the friction member 50 biased by the separation spring 12, and to apply to the friction member 50 the circumferential force for moving the cage 7 to the engagement position.

In the rotation braking device shown in FIG. 5, the friction member 50 is configured to be attracted toward the armature 51 when the electromagnet 9 is energized, at least one of opposed surfaces 50a and 50b of the friction member 50 and the armature 51 includes the raceway groove 50b, 51b extending circumferentially, the plurality of rolling elements 52 circumferentially rollable along the raceway groove 50b, 51b are disposed between the opposed surfaces 50a and 50b, and the friction member 50 and the armature 51 are disposed so as to be supported by the plurality of rolling elements 52 in a manner that allows relative rotation between the friction member 50 and the armature 51 when the electromagnet 9 is energized. As a result, when the electromagnet 9 is energized, the friction member 50 is attracted toward the armature 51, and the friction member 50 is supported via the plurality of rolling elements 52, thereby allowing the position of the friction member 50 to be stabilized. In addition, when the electromagnet 9 is energized from the de-energized state, even if the friction member 50 is attracted toward the armature 51, the friction member 50 is supported by the plurality of rolling elements 52 circumferentially rollable along the raceway groove 50b, 51b, so as to be rotatable relative to the armature 51. This makes it possible to reduce the friction resistance from the stationary system acting on the friction member 50, and to facilitate the return of the cage 7 to the disengagement position by the spring force of the centering spring 8.

In the rotation braking device shown in FIG. 5, since the friction member 50 and the armature 51 are each formed of a magnetic material, a magnetic circuit can be formed such that both the friction member 50 and the armature 51 are attracted by the magnetic force of the electromagnet 9.

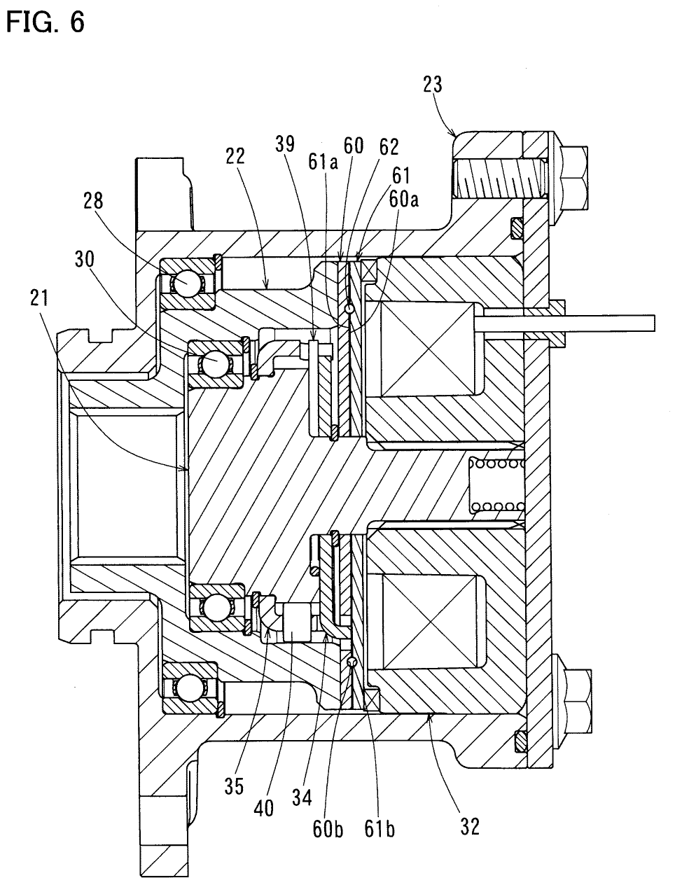

A rotation braking device according to a fourth embodiment, as the other example employing the second means of the present invention, will be described with reference to FIG. 6. Since the fourth embodiment is a variation of the second embodiment, the following description focuses only on the differences from the second embodiment, and corresponding components are denoted by the same reference numerals.

In the rotation braking device shown in FIG. 6, at least one of the opposed surfaces 60a and 61a of the friction member 60 and the armature 61 are provided with a circumferentially extending raceway groove 60b, 61b. The plurality of rolling elements 62 circumferentially rollable along the raceway groove 60b, 61b, are disposed between the opposed surfaces 60a and 61a. The friction member 60 and the armature 61 are supported by the plurality of rolling elements 62 so as to be rotatable relative to each other when the electromagnet 32 is energized. Since specific structures, operations, and effects of the raceway groove 60b, 61b and the rolling elements 62 are similar to those in the third embodiment, detailed description thereof is omitted.

In the above-described respective embodiments, it is preferable that a heat treatment for increasing surface hardness be applied to the friction member 10, 36, 50, 60 and the armature 11, 37, 51, 61 (see FIGS. 1, 4, 5, and 6).

The heat treatment described above may be appropriately selected depending on the base material of the armature. When the base material is copper, examples of applicable heat treatment include carburizing and quenching, nitriding, soft nitriding, and high-frequency quenching.

For example, in the friction member 10 and the armature 11 shown in FIGS. 1 and 3, the heat treatment is applied to the base materials 10d and 11b, a heat treatment for reducing friction resistance is applied to the heat-treated surfaces so as to form the contact surfaces 10c and 11a. Accordingly, even if the base materials 10d and 11d come into a sliding state due to wear of the contact surfaces 10c and 11a, or if areas of the base materials 10d and 11b other than the contact surfaces 10c and 11a come into a sliding state due to improper tilting of the friction member 10, the armature 11, or the like, wear of the sliding portion can also be prevented.

In addition, in the friction member 50 and the armature 51 shown in FIG. 5, heat treatment is applied to the base materials of the friction member 50 and the armature 51 in which the raceway grooves 50b and 51b are formed, respectively. Accordingly, surface damage to the raceway grooves 50b and 51b can be prevented.

While, in the above-mentioned embodiments, an example is shown in which the cylindrical surface is formed on the outer member and the cam surfaces are formed on the inner member, an alternative arrangement may be adopted in which the cylindrical surface is formed on the inner member and the cam surfaces are formed on the inner peripheral portion of the outer member. In addition, a sprag may be used as the engagement element, and the tilted position of the sprag may be controlled by the relative rotation of the cage.

In addition, while, in the above-mentioned embodiments, an example is shown in which the friction surface portion is formed on the end surface of the outer member, the friction surface portion may be formed on a different member coupled to the outer member.

The above-described embodiments are mere examples in every respect, and the present invention is not limited thereto. The scope of the present invention is indicated by not the above description but the claims, and should be understood to include all modifications within the meaning and scope equivalent to the scope of the claims.

### DESCRIPTION OF REFERENCE NUMERALS

1, 21: Inner member
2, 22: Outer member
2b, 22b: Friction surface portion
6, 40: Engagement element
7, 35: Cage
8, 39: Centering spring
9, 32: Electromagnet
10, 36, 50, 60: Friction member
11, 37, 51, 61: Armature
10c, 11a, 36b, 37b: Contact surface
12, 38: Separation spring
50a, 60a, 51a, 61a: Opposed surfaces
50b, 60b, 51b, 61b: Raceway groove
52, 62: Rolling element

1. A rotation braking device comprising:
an inner member;
an outer member surrounding the inner member;
engagement elements disposed between the outer member and the inner member;
a cage retaining the engagement elements, and disposed to be circumferentially movable between an engagement position at which the engagement elements are engaged with the outer member and the inner member, and a disengagement position at which the engagement elements are disengaged from the outer member and the inner member;
a centering spring for elastically holding the cage at the disengagement position, the centering spring being rotationally fixed to the cage;
an electromagnet;
an axially movable friction member rotationally fixed to the cage;
an armature axially opposed to the electromagnet between the electromagnet and the friction member;
a separation spring for axially biasing the friction member in a direction away from the electromagnet via the armature; and
a friction surface portion configured to axially receive the friction member biased by the separation spring, and to apply to the friction member a circumferential force for moving the cage to the engagement position,
characterized in that the friction member is configured to be attracted to the armature when the electromagnet is energized,
wherein a surface treatment for reducing friction resistance is applied to at least one of opposed contact surfaces of the friction member and the armature.

2. The rotation braking device according to claim 1, wherein the friction member and the armature are each formed of a magnetic material.

3. The rotation braking device according to claim 1, wherein a heat treatment for increasing surface hardness is applied to the friction member and the armature.

4. The rotation braking device according to claim 2, wherein a heat treatment for increasing surface hardness is applied to the friction member and the armature.

5. A rotation braking device comprising:
an inner member;
an outer member surrounding the inner member;
engagement elements disposed between the outer member and the inner member;
a cage retaining the engagement elements, and disposed to be circumferentially movable between an engagement position at which the engagement elements are engaged with the outer member and the inner member, and a disengagement position at which the engagement elements are disengaged from the outer member and the inner member;
a centering spring for elastically holding the cage at the disengagement position, the centering spring being rotationally fixed to the cage;
an electromagnet;
an axially movable friction member rotationally fixed to the cage;
an armature axially opposed to the electromagnet between the electromagnet and the friction member;
a separation spring for axially biasing the friction member in a direction away from the electromagnet via the armature; and
a friction surface portion configured to axially receive the friction member biased by the separation spring, and to apply to the friction member a circumferential force for moving the cage to the engagement position,
characterized in that the friction member is configured to be attracted toward the armature when the electromagnet is energized,
wherein at least one of opposed surfaces of the friction member and the armature has a circumferentially extending raceway groove,
wherein a plurality of rolling elements circumferentially rollable along the raceway groove are disposed between the opposed surfaces, and
wherein the friction member and the armature are disposed so as to be supported by the rolling elements in a manner that allows relative rotation between the friction member and the armature when the electromagnet is energized.

6. The rotation braking device according to claim 5, wherein the friction member and the armature are each formed of a magnetic material.

7. The rotation braking device according to claim 5, wherein a heat treatment for increasing surface hardness is applied to the friction member and the armature.

8. The rotation braking device according to claim 6, wherein a heat treatment for increasing surface hardness is applied to the friction member and the armature.
